(19) United States
(12) Patent Application Publication
(10) Pub. No.: US 2010/0176571 A1
(43) Pub. Date: Jul. 15, 2010

(54) DUAL PEDALING MECHANISM BICYCLE

(76) Inventor: FARAMARZ ISAAC MASHIAN, Los Angeles, CA (US)

Correspondence Address: John Alumit, 16830 Ventura Blvd. Suite 360, Encino, CA, 91436, US

(21) Appl. No.: 12/351,735

(22) Filed: Jan. 9, 2009

(51) Int. Cl. B62M 1/12; B62M 1/00; B62M 9/00

(52) U.S. Cl. 280/234

(57) ABSTRACT

A dual propulsion bicycle comprises a second drive mechanism at the front of the bicycle. The second drive mechanism comprises a sprocket and chain assembly, with a first sprocket associated with the front wheel and a second sprocket associated with a steering mechanism, wherein the handles can be moved relative to the steering mechanism to adjust the manner in which the handles are manipulated to achieve propulsion. Additionally, the handles can be positioned in the manner of a conventional bicycle to allow a rider to propel the bicycle conventionally.

### CROSS-REFERENCE TO RELATED APPLICATION

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

Bicycles are known in the art, as are bicycles with alternative means of propulsion. U.S. Pat. No. 6,099,009 to Schroeder discloses separate chain-and-sprocket drive mechanisms for the front and rear wheels. The front wheel drive includes a cross shaft and a pair of crank arms at the ends of the cross shaft, both of which crank arms extend in the same radial direction from the cross shaft. The cross shaft and crank arms serve the dual function of enabling steering the bicycle similarly to conventional handlebars and also driving the chain-and-sprocket mechanism for the front wheel. At the ends of the crank arms, a pair of outwardly-directed diametrically-opposed axles form bearing surfaces for a pair of freely rotatable hand grips. A drive sprocket on the cross shaft is rotated by cranking the hand grips in a continuous 360 degree rotary motion, and through the chain, driving a driven sprocket associated with the front wheel. A clutch is provided to lock the cross shaft in any of a plurality of angular positions to enable the drive to be declutched from a driving relationship with the front wheel and used solely for steering. A first lever system is actuated by sliding one of the hand grips axially to operate the clutch, and a second lever system is actuated through conventional lever and cable means from the other of the hand grips for actuating caliper brakes for both wheels. Inboard hand grips are provided on the cross shaft for steering and for enabling performing the brake operation through the second lever system while steering from the inboard grips

U.S. Pat. App. No. 2004/0113384 discloses a bicycle of the type driven by operation of a handle. A shaft rod of the bicycle is installed with a hinge so as to enable the handle to rotate forward or backward. The handle is bent by a constant angle on the basis of the hinge, thereby being divided into both upper and lower portions on the basis of the hinge. The handle is formed at the lower portion thereof with an elongated guide bore, and a roller is inserted inside the guide bore so as to move upward and downward along the guide bore. The roller is connected to the upper end of a rod, which is installed so as to move upward and downward in a rectilinear course according to pulling and pushing operation of the handle. The rod is associated at the lower end thereof with a rotating cam by means of a connection link. The cam is installed at one side thereof with a driving gear rotating along with the cam, and the driving gear is provided at an internal portion thereof with a ratchet. The ratchet is adapted to rotate in only one direction due to a stopper. The driving gear is installed around an outer periphery thereof with an auxiliary sprocket rotating along with the driving gear. A center shaft of the front wheel is integrally installed with a center shaft gear so as to be associated with the auxiliary sprocket through a chain. Since the front wheel of the bicycle can be driven by operation of the handle, the bicycle of the present invention enables the rider to effectively perform exercise of his/her upper body as well as his/her lower body, thereby inducing uniform development of the whole body.

The aforementioned references do not address the problem of changing the orientation of the hand propulsion component of the bicycle, and do not permit a rider to alter the configuration of the handlebars to allow a rider to set the handles in a conventional position.

Therefore it is an object of the present invention to provide a dual propulsion bicycle, driven by conventional pedals and by means of a propulsion mechanism associated with the bicycle steering mechanism. Another object of the invention is to provide a bicycle wherein propulsion is achieved by pedaling with the hands. Another object of the invention is to provide a bicycle wherein the hand position can be altered to provide a rowing movement or a pedaling movement or another movement by virtue of various placements of the handles. Yet another object of the present invention is to provide a dual propulsion bicycle wherein the handles can be fixed in the manner of a conventional bicycle. These and other objects will become clear from the appended summary, description and claims.

### SUMMARY

The bicycle of the present invention comprises a frame, rear wheel, front wheel, and fork, wherein the lower termini straddle and supporting the front wheel. The fork has a stem at its upper end that connects the fork to the frame. A first chain-and-sprocket drive mechanism drives the rear wheel and allows the bicycle to be propelled by the legs and feet of a rider. The bicycle departs from conventional design by virtue of a second drive mechanism which drives the front wheel. The second drive mechanism operates by cranking the handle bars of a steering mechanism at the upper terminus of the drive mechanism. The steering mechanism comprises a modified pedaling mechanism

The second drive mechanism comprises a first sprocket adjacent the front wheel, a chain extending from the first sprocket, through a chain guide toward the upper terminus of the second drive mechanism that prevents the chain from interfering with a rider and helps remove excess movement in the chain. The steering mechanism is disposed at the top of the fork and comprises a housing with a shaft, second sprocket and a locking disk connected to the shaft. The locking disk rotates with the shaft adjacent to the housing.

Two arm bars extend from the shaft in the plane of the second sprocket, and grip bars attached to each arm bar allow a rider to hold onto the steering mechanism. The grip bars can be fixed in multiple positions along the arm bars, and the locking disk can be locked in place to prevent rotational movement of the shaft. The arm bars have a channel and lock mechanism that allows the grip bars to be moved to a desired position along the arm bar, and the grip bars comprise a spring-loaded feature that allows a rider to pull them outward relative to the arm bars, slide them into a desired position, and automatically lock into position when released.

### BRIEF DESCRIPTION OF THE FIGURES

FIG. 1 is a perspective view of a dual pedaling bicycle according to the present invention.

FIG. 2 is a perspective view of the steering mechanism of the dual pedaling bicycle.

### DESCRIPTION

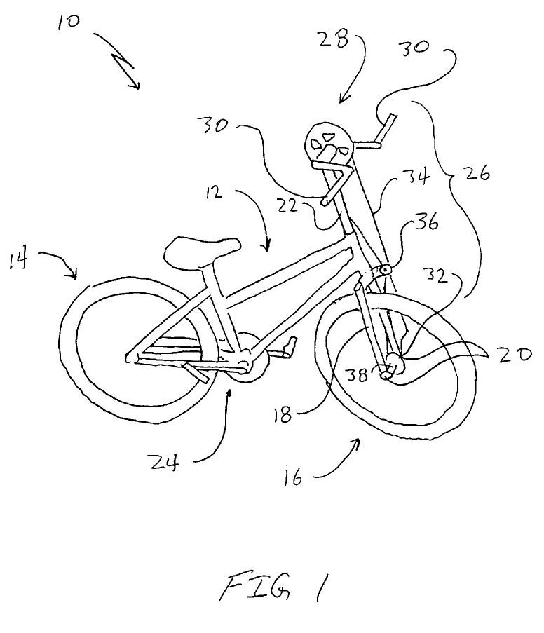

Referring to FIG. 1, the bicycle 10 of the present invention comprises a frame 12, a rear wheel 14, a front wheel 16, and a fork 18 with two lower termini 20 straddling and supporting the front wheel in a rotatable configuration at the fork's 18 lower end. The fork has a stem 22 at its upper end which connects the fork 18 to the frame 12 in a pivotal manner that allows the front wheel 16 to steer relative to the stem 22. A first chain-and-sprocket drive mechanism 24 for driving the rear wheel 14 is disposed in the conventional location, and allows the bicycle to be propelled by pedaling the legs and feet of a rider.

Still referring to FIG. 1, the bicycle departs from conventional design by virtue of a second chain-and-sprocket drive mechanism 26 which serves as a propulsion means for driving the front wheel 16. The second chain-and-sprocket drive mechanism 26 operates by cranking the upper terminus of the drive mechanism. A rider accomplishes this utilizing the hands and arms. The upper terminus of the second chain-and-sprocket mechanism 26 comprises a steering mechanism 28. The steering mechanism 28 is similar to a conventional bicycle in that it comprises two handles 30 and is connected to the fork 18. However, instead of a handle bar, the steering mechanism comprises a modified pedaling mechanism wherein each of the wheels is capable of freewheeling forward movement when coasting and a conventional brake means selectively applies a braking force to the wheels. Furthermore, the first and second drive mechanisms for the wheels are capable of independent operation, whereby the bicycle may be driven by leg pedaling alone, cranking of the upper terminus of the second drive mechanism alone, or simultaneous pedaling and cranking together.

Still referring to FIG. 1, the second chain-and-sprocket drive mechanism comprises a first sprocket 32 adjacent the front wheel 16. A chain 34 extends from the first sprocket, through a chain guide 36 toward the upper terminus of the second chain-and-sprocket mechanism. The chain guide 36 prevents the chain from interfering with a rider, and also helps to remove excess movement in the chain that could affect performance. A shaft 38 extends from one lower terminus of the fork 18 to the other lower terminus, and rotates along with a bearing mechanism and first sprocket similar to the rear wheel of a conventional bicycle.

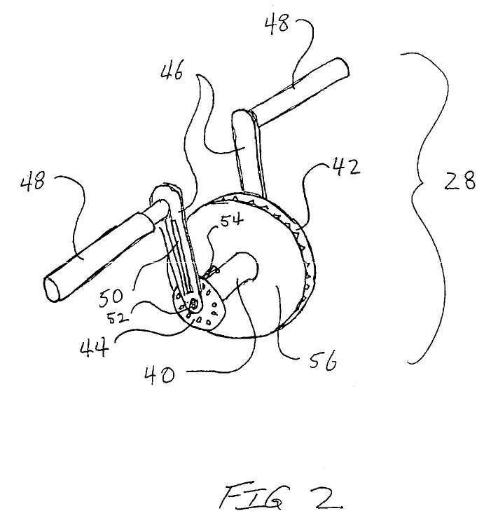

Referring to FIG. 2, the upper terminus of the second chain-and-sprocket mechanism comprises a steering mechanism 28. The steering mechanism 28 is disposed at the top of the fork 18, and comprises a housing 40 with a shaft (not shown) and a second sprocket 42. The shaft extends through the housing 40 and second sprocket 42 and also comprises a locking disk 44 connected to the shaft. The locking disk 44 rotates with the shaft adjacent to the housing.

Still referring to FIG. 2, two arm bars 46 extend from the shaft in the plane of the second sprocket 42, and a grip bars 48 attached to each arm bar 46 allow a rider to hold onto the steering mechanism 28. The grip bars 48 can be fixed in multiple positions along the arm bars 46, and the locking disk 44 can be locked in place to prevent rotational movement of the shaft.

Still referring to FIG. 2, in a preferred embodiment, each grip bar 48 comprises an inner structure that is connected to, and rotates with an arm bar 46, and an outer structure that remains in position relative to a rider's hand. In a further preferred embodiment, the arm bars have a channel and lock mechanism 50 that allows the grip bars 48 to be moved to a desired position along the arm bar 46. In yet another preferred embodiment, the grip bars 48 comprise a spring-loaded feature that allows a rider to pull them outward relative to the arm bars 46, slide them into a desired position, and automatically lock into position when released.

The arm bars 46, in addition to having a means for allowing the grip bars 48 to move along their lengths, also comprise a mechanism 52 for allowing them to change position relative to the shaft. In this manner, the arm bars can be positioned so that they are adjacent to each other, providing a rowing type movement of the steering mechanism, opposite each other, providing a pedaling type movement similar to a conventional bicycle, or other configurations. In a further preferred embodiment, the arm bars can be individually removed from the shaft, and a grip bar individually installed in place of an arm bar to allow the rider to ride conventionally.

A locking pin 54 is disposed on the housing of the steering mechanism 28 and is designed to engage the locking disk 44. When the pin 54 engages the disk 44, rotational movement of the shaft is prevented, allowing the bicycle to ride like a conventional bicycle with handlebars.

In a further preferred embodiment, the second sprocket comprises a housing 56 to prevent exposure of the sprocket teeth to a rider. In yet another preferred embodiment, the first sprocket of the second chain-and-sprocket mechanism comprises multiple gears which may be changed by means of derailleur gears controlled by a rider. In another preferred embodiment, the bicycle comprises a seat with a seat back to prevent a rider from sliding backward when applying pressure to the steering mechanism.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A bicycle having a frame, a rear wheel, a front wheel, and a fork with two lower termini straddling and supporting the front wheel in a rotatable configuration at the fork's lower end, wherein the fork has a stem at its upper end for pivotally mounting the fork in the frame to enable the front wheel to steer relative to the stem, a first chain-and-sprocket drive mechanism for driving the rear wheel by pedaling of a rider's legs and feet, a second chain-and-sprocket drive mechanism for driving the front wheel by cranking the upper terminus of the drive mechanism, each of the wheels provided with means for enabling freewheeling forward movement when coasting, brake means for selectively applying a braking force to the wheels, the first and second drive mechanisms for the wheels being independent whereby the bicycle may be driven by leg pedaling alone, cranking of the upper terminus of the drive mechanism alone, or simultaneous pedaling and cranking together, the second drive mechanism comprising:
a. a shaft extending from one lower terminus of the fork to the other lower terminus, wherein the shaft is rotatable along its axis adjacent a bearing mechanism and supporting a first sprocket;
b. a chain connecting the first sprocket to the upper terminus of the second chain-and-sprocket drive mechanism;
c. a second sprocket at the upper terminus of the second chain-and-sprocket drive mechanism connected to a steering mechanism, wherein the steering mechanism comprises a shaft extending through the second sprocket, a locking disk connected to the shaft, two arm bars extending from the shaft and a grip bar attached to each arm bar, wherein the grip bars can be fixed in multiple positions on the arm bars, and the shaft can be locked in place to prevent rotational movement.

2. The bicycle of claim 1, wherein the grip bars comprise an inner structure that rotates relative to an outer structure.

3. The bicycle of claim 1, wherein each of the grip bars comprises a spring-loaded connection allowing it to be disengaged from one position along an arm bar, slid relative to the bar, and re-engaged at another position along the bar.

3. The bicycle of claim 1, wherein the arm bars can be repositioned to allow them to extend from the shaft at different angles relative to each other.

4. The bicycle of claim 1, wherein the arm bars can be individually removed, allowing a grip bar to be fastened directly to the shaft.

5. The bicycle of claim 1, wherein the shaft is disposed in a housing, and a locking pin affixed to the housing engages the locking disk to prevent rotational movement of the shaft.

6. The bicycle of claim 1, wherein the second sprocket comprises a housing to prevent exposure of the sprocket teeth to a rider.

7. The bicycle of claim 1, wherein the bicycle comprises a chain guide associated with the second chain-and-sprocket mechanism to prevent undesired movement of a chain relative to the bicycle.

8. The bicycle of claim 1, wherein the first sprocket of the second chain-and-sprocket mechanism comprises multiple gears.

9. The bicycle of claim 8, wherein the gears of the first sprocket of the second chain-and-sprocket mechanism are changed by movement of derailleur gears.

10. The bicycle of claim 1, wherein the bicycle comprises a seat with a means for preventing a rider from sliding backward when applying pressure to the second chain-and-sprocket drive mechanism.

11. The bicycle of claim 10, wherein the means for preventing a rider from sliding backward comprises a seat back.
